(19) United States
(12) Patent Application Publication
(10) Pub. No.: US 2015/0244045 A1
(43) Pub. Date: Aug. 27, 2015

(54) BATTERY MODULE

(71) Applicants: UER Technology (SHENZHEN) LIMITED, Shenzhen (CN); UER Technology Corporation, Miaoli County (TW)

(72) Inventors: RAY-TANG SUN, Miaoli (TW); CHUNG-DA YANG, Miaoli (TW); CHIN-HAO TSAO, Miaoli (TW)

(21) Appl. No.: 14/600,580

(22) Filed: Jan. 20, 2015

(30) Foreign Application Priority Data
Feb. 24, 2014 (TW) 103106146

(51) Int. Cl. H01M 10/6563; H02J 7/00; H01M 2/12; H01M 10/42

(52) U.S. Cl. CPC H01M 10/6563; H01M 2/1264; H01M 10/425; H02J 7/0042

(57) ABSTRACT

A battery module includes a casing, and a battery assembly, a frequency converting assembly, and a heat dissipation assembly received in the casing. The casing defines a first vent and a second vent. The casing includes a top portion and an opposite bottom portion. The first vent and the second vent are respectively adjacent to the bottom portion and the top portion. The frequency converting assembly is electrically connected to the battery assembly. The heat dissipation assembly includes a fan secured to the casing and facing the second vent. The fan is configured to rotate so as to draw air into the casing via the first vent, cause the air to flow through the battery assembly and the frequency converting assembly, and draw the air out of the casing via the second vent.

### CROSS-REFERENCE TO RELATED APPLICATIONS

This application is related co-pending U.S. patent application of Attorney Docket No. US54979 entitled “BATTERY MODULE”, and invented by Sun et al. This application has the same assignee as the present application. The above-identified application is incorporated herein by reference.

### FIELD

The subject matter herein generally relates to a battery module.

### BACKGROUND

Heat can be created during use of a battery module including battery cells and frequency converters. Effective heat dissipation is needed for the battery module.

### BRIEF DESCRIPTION OF THE DRAWINGS

Implementations of the present technology will now be described, by way of example only, with reference to the attached figure.

FIG. 1 is an isometric view of an embodiment of a battery module.

FIG. 2 is an exploded isometric view of the battery module of FIG. 1.

FIG. 3 is similar to FIG. 2, but showing the battery module from another angle.

FIG. 4 is a partially-assembled isometric view of the battery module of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

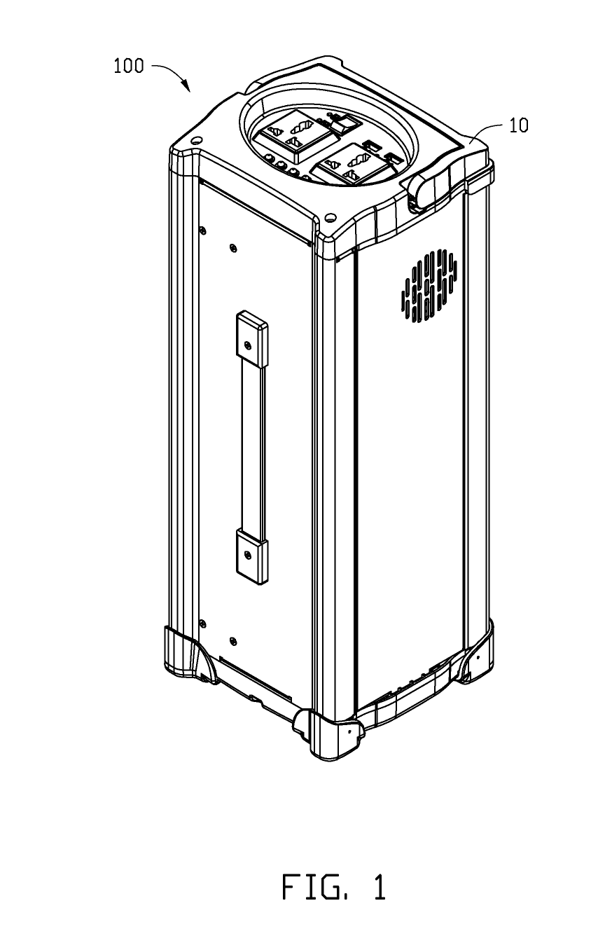

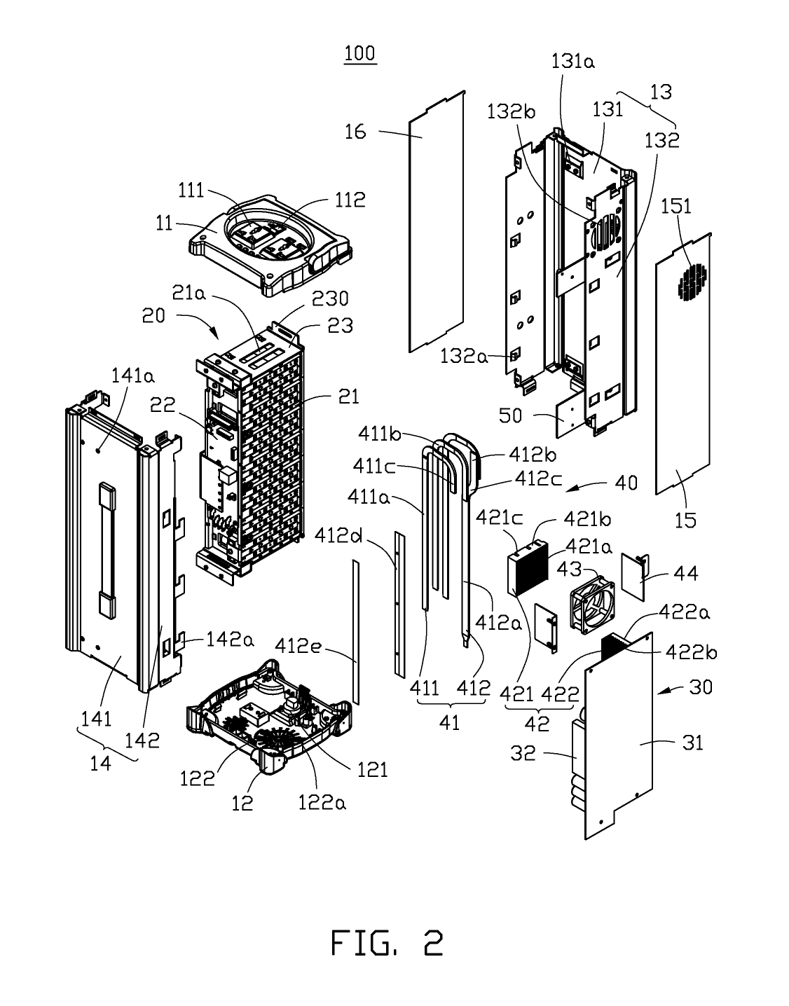

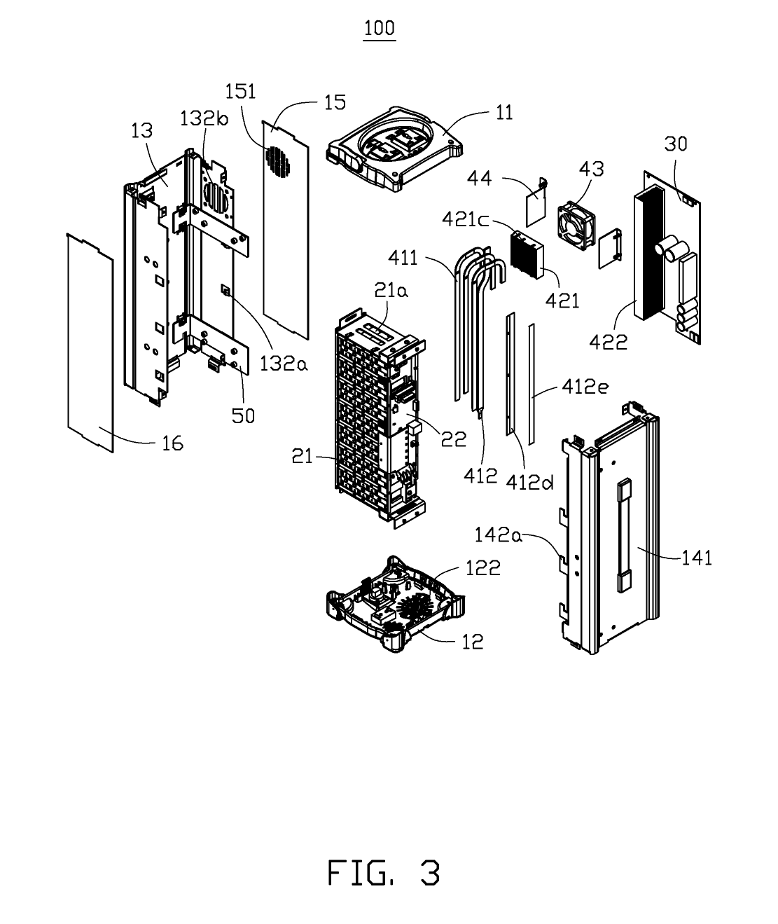

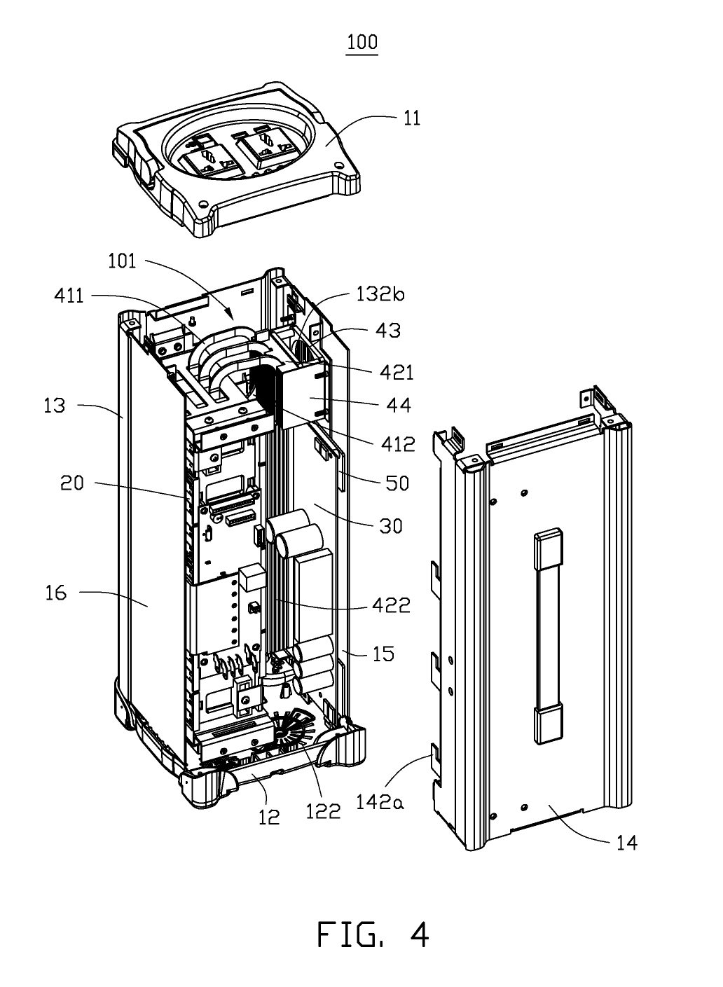

FIGS. 1-4 illustrate a battery module 100 including a casing 10, a battery assembly 20, a frequency converting assembly 30, and a heat dissipation assembly 40.

The casing 10 includes a top portion 11, a bottom portion 12, a first securing wall 13, a second securing wall 14, a first cover 15, and a second cover 16. The top portion 11 and the bottom portion 12 face each other. The first securing wall 13, the second securing wall 14, the first cover 15, and the second cover 16 are connected to and located between the top portion 11 and the bottom portion 12. The top portion 11, the bottom portion 12, the first securing wall 13, the second securing wall 14, the first cover 15, and the second cover 16 cooperatively define a receiving space 101 for receiving the battery assembly 20, the frequency converting assembly 30, and the heat dissipation assembly 40.

The top portion 11 includes at least one power jack 111 and a power switch 112. The power jack 111 is electrically coupled to the battery assembly 20. A peripheral device (not shown) can be charged via the power jack 111. The power switch 112 is configured to selectively connect or disconnect the power jack 111 to the battery assembly 20 when switched on or off.

The bottom portion 12 includes a power plug 121 electrically coupled to the battery assembly 20. As such, the battery assembly 20 can be charged via the power plug 121 that can be coupled to an external power source. The bottom portion 12 defines a first vent 122.

The first securing wall 13 includes a first base 131 and two first securing plates 132. The first base 131 is substantially rectangular, and includes a number of first securing portions 131a for securing the battery assembly 20 to the first securing wall 13. The two first securing plates 132 are connected to two opposite sides of the first base 131, substantially parallel to each other, and face each other. The two first securing plates 132 define at least one pair of latch slot 132a which can be elastically deformed when pressed. A second vent 132b is defined in one of the first securing plates 132 and adjacent to the top portion 11. In another embodiment, the first vent 122 can be defined in the second securing wall 14 and adjacent to the bottom portion 12 to cause a distance between the first vent 122 and the second vent 132b to increase. In yet another embodiment, the first vent 122 can be defined in the bottom portion 11, and the second vent 132b can be defined in the top portion 11

The second securing wall 14 includes a second base 141 and two second securing plates 142. The second base 141 has the same features as the first base 131, and includes a number of second securing portions 141a for further securing the battery assembly 20 to the second securing wall 14. The two second securing plates 142 are connected to two opposite sides of the second base 141, substantially parallel to each other, and face each other. The two second securing plates 142 include at least one pair of hooks 142a corresponding to the pair of latch slots 132a. In at least one embodiment, each pair of hooks 142a extends from the edges of the second securing plates 142 away from the second base 141, and includes two L-shaped hooks 142a.

In at least one embodiment, a distance between each pair of latch slots 132a is less than a distance between the corresponding pair of hooks 142a. As such, when each pair of hooks 142a is inserted into a space between the corresponding pair of latch slots 432a, the pair of latch slots 132a is elastically deform, and further rebounds to cause the pair of hooks 142a to snap into the pair of latching slots 132a, thereby locking the first securing plates 132 to the second securing plates 142.

The first cover 15 covers the first securing plate 132 defining the second vent 132b and the corresponding second securing plates 142. The first cover 15 defines a third vent 151 facing the second vent 132b. The second cover 16 covers the other first securing plate 132 and the corresponding second securing plates 142.

The battery assembly 20 includes a battery unit 21, a circuit board 22, and a fixing frame 23. The battery unit 21 and the circuit board 22 are secured to the fixing frame 23. Two opposite sidewalls 230 of the fixing frame 23 are respectively secured to the first securing portions 131a and the second securing portions 141a. The battery unit 21 includes a number of battery cells 21a. The battery cells 21a are arranged orderly in an array, and are electrically coupled to each other in series or in parallel. The circuit board 22 is electrically connected to the battery unit 21, and is configured to control the battery cells 21a to selectively charge or discharge. In at least one embodiment, the fixing frame 23 is hollow and rectangular. The battery unit 21 is fixedly received in the fixing frame 23, and the circuit board 22 is secured to one of the sidewalls 230 of the fixing frame 23.

The frequency converting assembly 30 is electrically connected to the battery assembly 20. The frequency converting assembly 30 includes a base plate 31 secured to the casing 10 and a number of frequency converters 32 secured to the base plate 31. The frequency converters 32 are configured to adjust the frequency and voltage output by the battery assembly 20. In at least one embodiment, the base plate 31 is secured to the first securing wall 13 of the casing 10 via two supporting plates 50.

The heat dissipation assembly 40 includes a heat-conducting unit 41, and a heat-dissipating unit 42. The heat-dissipating unit 42 includes a first dissipation member 421 independent from the battery assembly 20 and the frequency converting assembly 30. The battery assembly 20 and the frequency converting assembly 30 are coupled to the first dissipation member 421 via the heat-conducting unit 41 to cause heat generated by the battery assembly 20 and the frequency converting assembly 30 to be conducted to the first dissipation member 421.

In at least one embodiment, the heat-conducting unit 41 includes a number of first heat-conducting pipes 411 and a second heat-conducting pipe 412. Each of the first heat-conducting pipes 411 includes a first heat-conducting portion 411a, a second heat-conducting portion 411b, and a connecting portion 411c connected to and located between the first and the second heat-conducting portion 411a, 411b. The first heat-conducting portion 411a of each of the first heat-conducting pipes 411 is inserted into a gap formed by two adjacent battery cells 21a. In at least one embodiment, the first and the second heat-conducting portion 411a, 411b are connected to two opposite ends of the connecting portion 411c, substantially parallel to each other, and face each other. A length of the first heat-conducting portion 411a is greater than a length of the second heat-conducting portion 411b. In at least one embodiment, each of the first circulation pipes 411 is made of heat-conductive material, such as copper (Cu) and aluminum (Al).

The second heat-conducting pipe 412 includes a first heat-conducting portion 412a, a second heat-conducting portion 412b, and a connecting portion 412c connected to and located between the first and the second heat-conducting portions 412a, 412b. In at least one embodiment, the first and the second heat-conducting portions 412a, 412b extend from two opposite ends of the connecting portion 412c and away from each other, and are substantially parallel to each other. The second heat-conducting pipe 412 further includes a heat-conducting layer 412d attached to a surface of the first heat-conducting portion 412a.

The first dissipation member 421 includes a first base portion 421a and a number of first dissipation fins 421b. The first dissipation fins 421b are secured to the first base portion 421a, substantially parallel and between each other, and spaced from each other to form a number of receiving grooves 421c. The second heat-conducting portion 411b of each of the first heat-conducting pipes 411 is inserted into one receiving groove 421c of the first dissipation fins 421b, and is coupled to the two adjacent battery cells 21a.

The heat-dissipating unit 42 further includes a second dissipation member 422. The second dissipation member 422 is attached to the frequency converting assembly 30 to cause the heat generated by the frequency converting assembly 30 to be firstly conducted to the second dissipation member 422. In at least one embodiment, the second dissipation member 422 is secured to the base plate 31 of the frequency converting assembly 30. The second dissipation member 422 includes a second base portion 422a and a number of second dissipation fins 422b secured to the second base portion 422a. The heat-conducting layer 412d of the second heat-conducting pipe 412 is secured to the second base portion 422a via thermal grease 412e. The second heat-conducting portion 412b of the second heat-conducting pipe 412 is inserted into one receiving groove 421c of the first dissipation fins 421b, and is coupled to the first dissipation fins 421b. As such, the heat conducted to the second dissipation member 422 can be further conducted to the first dissipation fins 421b via the second heat-conducting pipe 412.

The heat dissipation assembly 40 further includes a fan 43. The fan 43 is secured to the casing 10, and faces the second vent 132b and the third vent 151. In at least one embodiment, the fan 43 is attached to a surface of the first base portion 421a of the first dissipation member 421 away from the first dissipation fins 421b. The first securing wall 13 further includes two connecting plates 44 secured to the first base 131. The two connecting plates 44 clamp the fan 43 and the first dissipation member 421, thereby securing the fan 43 to the casing 10.

In use, the heat generated by the battery assembly 20 is conducted to the first dissipation member 421 via the first heat-conducting pipes 411. The heat generated by the frequency converting assembly 30 is conducted to the first dissipation member 421 via the second dissipation member 422 and the second heat-conducting pipe 412. Furthermore, the fan 43 is configured to rotate so as to draw the air into the casing 10 via the first vent 122, forces the air to flow through the battery assembly 20, the frequency converting assembly 30, and the first dissipation member 421, and further draws the air out of the casing via the second vent 132b. As such, the heat generated by the battery assembly 20 and the frequency converting assembly 30, and the heat conducted to the first dissipation member 421 is dissipated. Since the distance between the first vent 122 and the second vent 132b increases, the travel distance of the air within the casing 10 is increased which allows the heat to be dissipated more efficiently.

In at least one embodiment, each of the first heat-conducting pipes 411 further receives cooling liquid which flows between the first and the second heat-conducting portions 411a, 411b to dissipate heat more efficiently.

In at least one embodiment, the first vent 122 is divided into a number of fan-shaped gaps 122a which divide the air drawn into the casing 10 into divisional air streams. As such, the air can be evenly drawn into the casing 10.

It is to be understood, even though information and advantages of the present embodiments have been set forth in the foregoing description, together with details of the structures and functions of the present embodiments, the disclosure is illustrative only; changes may be made in the details, especially in matters of shape, size, and arrangement of parts within the principles of the present embodiments to the full extent indicated by the plain meaning of the terms in which the appended claims are expressed.

What is claimed is:

1. A battery module comprising:
a casing defining a receiving space, a first vent, and a second vent, the casing comprising a top portion and an opposite bottom portion, the first vent and the second vent respectively adjacent to the bottom portion and the top portion;
a battery assembly received in the receiving space;
a frequency converting assembly received in the receiving space and electrically connected to the battery assembly; and
a heat dissipation assembly received in the receiving space, and comprising a fan secured to the casing and facing the second vent, wherein the fan is configured to rotate so as to draw air into the casing via the first vent, cause the air to flow through the battery assembly and the frequency converting assembly, and draw the air out of the casing via the second vent.

2. The battery module of claim 1, wherein the casing further comprises a first securing wall and a second securing wall; the first securing wall and the second securing wall are connected to and located between the top portion and the bottom portion; the top portion, the bottom portion, the first securing wall, and the second securing wall cooperatively define the receiving space.

3. The battery module of claim 2, wherein the first vent is defined at the bottom portion; and the second vent is defined in the first securing wall and adjacent to the top portion.

4. The battery module of claim 2, wherein the top portion comprises at least one power jack and a power switch; the power jack is electrically coupled to the battery assembly; the power switch is configured to selectively connect or disconnect the power jack to the battery assembly when switched on or off.

5. The battery module of claim 2, wherein the bottom portion comprises a power plug electrically coupled to the battery assembly.

6. The battery module of claim 2, wherein the first securing wall comprises a first base and two first securing plates; the two first securing plates are connected to two opposite sides of the first base, substantially parallel to each other, and face each other; the second securing wall comprises a second base and two second securing plates; the two second securing plates are connected to two opposite sides of the second base, substantially parallel to each other, and face each other; the first securing plates are locked to the second securing plates.

7. The battery module of claim 6, wherein the first base comprises a plurality of first securing portions for securing the battery assembly to the first securing wall; the second base comprises a plurality of second securing portions for further securing the battery assembly to the second securing wall.

8. The battery module of claim 6, wherein the two first securing plates define at least one pair of latch slots; the two second securing plates comprise at least one pair of hooks each corresponding to one pair of latch slots; each pair of hooks snaps into the corresponding pair of latching slots, thereby locking the first securing plates to the second securing plates.

9. The battery module of claim 6, wherein the casing further comprises a first cover and a second cover; the first cover covers the first securing plate defining the second vent and the corresponding second securing plates, and defines a third vent facing the second vent; the second cover covers the other first securing plate and the corresponding second securing plates.

10. The battery module of claim 7, wherein the battery assembly comprises a battery unit, a circuit board, and a fixing frame; the battery unit and the circuit board are secured to the fixing frame; two opposite sidewalls of the fixing frame are respectively secured to the first securing portions and the second securing portions; the circuit board is electrically connected to the battery unit, and is configured to control the battery cells to selectively charge or discharge.

11. The battery module of claim 10, wherein the fixing frame is hollow and rectangular; the battery unit is fixedly received in the fixing frame, and the circuit board is secured to one sidewall of the fixing frame.

12. The battery module of claim 2, wherein the frequency converting assembly comprises a base plate secured to the casing and a plurality of frequency converters secured to the base plate; the base plate is secured to the first securing wall of the casing via two supporting plates.

13. The battery module of claim 2, wherein the first vent is divided into a plurality of fan-shaped gaps which divide the air drawn into the casing into divisional air streams.

14. A battery module comprising:
a casing defining a receiving space, a first vent, and a second vent, the casing comprising a top portion and an opposite bottom portion, the first vent and the second vent respectively defined in the bottom portion and the top portion;
a battery assembly received in the receiving space;
a frequency converting assembly received in the receiving space and electrically connected to the battery assembly; and
a heat dissipation assembly received in the receiving space, and comprising a fan secured to the casing and facing the second vent, wherein the fan is configured to rotate so as to draw air into the casing via the first vent, cause the air to flow through the battery assembly and the frequency converting assembly, and draw the air out of the casing via the second vent.

15. A battery module comprising:
a casing defining a receiving space, a first vent, and a second vent, the casing comprising a top portion, an opposite bottom portion, and a first secured wall connected to and located between the top portion and the bottom portion, the first vent defined in the bottom portion, the second vent defined in the first securing wall and adjacent to the top portion;
a battery assembly received in the receiving space;
a frequency converting assembly received in the receiving space and electrically connected to the battery assembly; and
a heat dissipation assembly received in the receiving space, and comprising a fan secured to the casing and facing the second vent, wherein the fan is configured to rotate so as to draw air into the casing via the first vent, cause the air to flow through the battery assembly and the frequency converting assembly, and draw the air out of the casing via the second vent.
